(19) United States
(12) Patent Application Publication
(10) Pub. No.: US 2025/0122230 A1
(43) Pub. Date: Apr. 17, 2025

(54) NITROGEN-CONTAINING SILANE COMPOUND AND METHOD FOR PRODUCING SAME

(71) Applicant: Shin-Etsu Chemical Co., Ltd., Tokyo (JP)

(72) Inventor: Yoichi Tonomura, Joetsu-shi (JP)

(73) Assignee: Shin-Etsu Chemical Co., Ltd., Tokyo (JP)

(21) Appl. No.: 18/904,552

(22) Filed: Oct. 2, 2024

(30) Foreign Application Priority Data
Oct. 17, 2023 (JP) 2023-179019

(51) Int. Cl. C07F 7/18

(52) U.S. Cl. CPC C07F 7/1876

(57) ABSTRACT

A nitrogen-containing silane compound having the general formula (1):

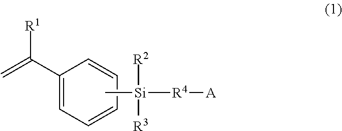

wherein R¹ represents a hydrogen atom or an unsubstituted monovalent hydrocarbon group,
   R² and R³ each independently represent an unsubstituted monovalent hydrocarbon group or a group having general formula (2),

—OR⁵ (2)
wherein R⁵ represents an unsubstituted monovalent hydrocarbon group,
   R⁴ represents an unsubstituted divalent hydrocarbon group,
   A represents a group having general formula (3) or general formula (4):

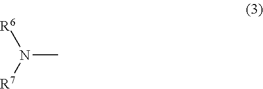

wherein R⁶ and R⁷ represent a monovalent hydrocarbon group in which a hetero atom may be interposed or a triorganosilyl group, and may be bonded to each other to form a ring together with a nitrogen atom to which they are bonded,

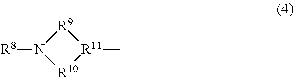

wherein R⁸ represents an unsubstituted monovalent hydrocarbon group or a triorganosilyl group, R⁹ and R¹⁰ represent a divalent hydrocarbon group, and R¹¹ represents C—H or a nitrogen atom.

### CROSS-REFERENCE TO RELATED APPLICATIONS

This non-provisional application claims priority under 35 U.S.C. § 119 (a) on Patent Application No. 2023-179019 filed in Japan on Oct. 17, 2023, the entire contents of which are hereby incorporated by reference.

### TECHNICAL FIELD

The present invention relates to a novel nitrogen-containing silane compound and a method for producing the same.

### BACKGROUND ART

Conventionally, various attempts have been made to improve the properties of a polymer compound, and as one example thereof, a method of introducing a functional group into a polymer compound is known.

As one of the functional group introduction methods, a method is known in which a compound having both a double bond and a functional group is reacted with a monomer to introduce a functional group into a polymer compound. For example, Patent Document 1 proposes a method using 1-[{N,N-bis (trimethylsilylamine)}dimethylsilyl}-2-{(4-vinylphenyl)dimethylsilyl}ethane, and Patent Document 2 proposes a method using 6-(N,N-bistrimethylsilylamino) myrcene.

It is known that when a polymer compound into which a functional group is introduced as described above is used in a rubber composition for tires, the interaction with silica which is a main filler in the rubber composition is improved.

### CITATION LIST

Patent Document 1: JP-A 2018-513897
Patent Document 2: JP-A 2022-519481

### SUMMARY OF THE INVENTION

In the method of Patent Document 1, a highly reactive Si—N bond is introduced into a polymer compound and bonded to a silanol group on the silica surface via a siloxane bond, thereby improving the affinity between the polymer and silica, but there is room for further improvement in the dispersibility of silica.

On the other hand, in the method of Patent Document 2, since the functional group to be introduced is an amino group, silica can be dispersed by the hydrogen bond of the amino group, and at the same time, the interaction with silica itself increases due to the high polarity of the amino group, so that the functional group introduction effect is high, but since the conjugated diene structure in which the double bond part is substituted is obtained, the reactivity at the time of introduction of the functional group decreases, and there is a possibility that the functional group cannot be sufficiently introduced into the polymer compound.

The present invention has been made in view of the above circumstances, and it is an object of the present invention to provide a novel nitrogen-containing silane compound useful as a polymer modifier, which makes it possible to more effectively improve the characteristics of a polymer compound by introduction of a functional group, and a method for producing the same.

As a result of intensive studies to achieve the above object, the present inventors have found that a specific nitrogen-containing silane compound is useful as a modifier capable of more effectively improving the interaction between silica and a polymer compound and improving the dispersibility of silica, and have completed the present invention.

That is, the present invention provides:
1. A nitrogen-containing silane compound having the following general formula (1):

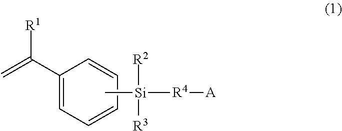

wherein R¹ represents a hydrogen atom or an unsubstituted monovalent hydrocarbon group having 1 to 20 carbon atoms,
R² and R³ each independently represent an unsubstituted monovalent hydrocarbon group having 1 to 20 carbon atoms or a group having the following general formula (2):

—OR⁵ (2)
wherein, R⁵ represents an unsubstituted monovalent hydrocarbon group having 1 to 20 carbon atoms,
R⁴ represents an unsubstituted divalent hydrocarbon group having 1 to 20 carbon atoms,
A represents a group having the following general formula (3) or a group having the following general formula (4):

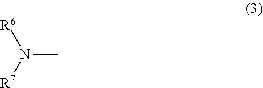

wherein, R⁶ and R⁷ represent a monovalent hydrocarbon group having 1 to 20 carbon atoms in which a hetero atom may be interposed or a triorganosilyl group, and may be bonded to each other to form a ring having 2 to 20 carbon atoms together with a nitrogen atom to which they are bonded:

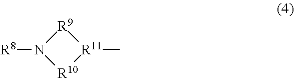

wherein, R⁸ represents an unsubstituted monovalent hydrocarbon group having 1 to 20 carbon atoms or a triorganosilyl group, R⁹ and R¹⁰ each independently represent a divalent hydrocarbon group having 1 to 20 carbon atoms, and R¹¹ represents C—H or a nitrogen atom; and
2. A method for producing the nitrogen-containing silane compound according to claim 1,
including reacting a nitrogen-containing silane compound having the following general formula (5):

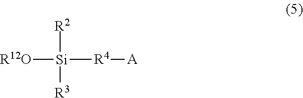

wherein, R² to R⁴ and A represent the same meaning as described above, and R¹² represents an unsubstituted monovalent hydrocarbon group having 1 to 20 carbon atoms with
a Grignard reagent having the following general formula (6):

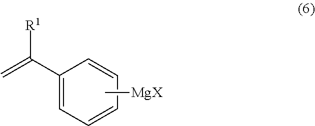

wherein, R¹ has the same meaning as described above, and X represents a chlorine atom, a bromine atom, or an iodine atom.

### Advantageous Effects of Invention

The nitrogen-containing silane compound of the present invention is useful as a polymer modifier or the like because it can more effectively improve the interaction between silica and a polymer and improve the dispersibility of silica.

### BRIEF DESCRIPTION OF THE DRAWINGS

FIG. 1 is a ¹H-NMR spectrum of 4-[(3-diethylaminopropyl)dimethoxysilyl]styrene obtained in Example 1;

FIG. 2 is an IR spectrum of 4-[(3-diethylaminopropyl)dimethoxysilyl]styrene obtained in Example 1;

FIG. 3 is a ¹H-NMR spectrum of 4-[[3-(4-methylpiperazine-1-yl)propyl]-dimethoxysilyl]styrene obtained in Example 2;

FIG. 4 is an IR spectrum of 4-[[3-(4-methylpiperazine-1-yl)propyl]dimethoxysilyl]-styrene obtained in Example 2;

FIG. 5 is a ¹H-NMR spectrum of 1-[4-[(3-diethylaminopropyl)dimethoxysilyl]-phenyl]-1-phenylethylene obtained in Example 3; and

FIG. 6 is an IR spectrum of 1-[4-[(3-diethylaminopropyl)dimethoxysilyl]-phenyl]-1-phenylethylene obtained in Example 3.

### DETAILED DESCRIPTION OF THE INVENTION

The nitrogen-containing silane compound of the present invention is a compound having the following general formula (1) (Hereinafter, the compound is referred to as “compound (1)”.).

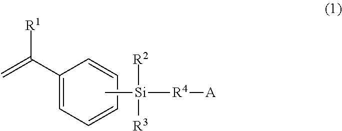

In the general formula (1), R¹ is a hydrogen atom or an unsubstituted monovalent hydrocarbon group having 1 to 20 carbon atoms, preferably 1 to 10 carbon atoms, more preferably 1 to 6 carbon atoms.

The monovalent hydrocarbon group of R¹ may be linear, branched, or cyclic, and specific examples thereof include linear alkyl groups such as methyl, ethyl, n-propyl, n-butyl, n-pentyl, n-hexyl, n-heptyl, n-octyl, n-nonyl, n-decyl, n-dodecyl, n-tetradecyl, n-hexadecyl, n-octadecyl, and n-icosyl groups; branched alkyl groups such as isopropyl, isobutyl, sec-butyl, tert-butyl, texyl, 2-ethylhexyl groups; cyclic alkyl groups such as cyclopentyl and cyclohexyl groups; alkenyl groups such as vinyl, allyl, 1-propenyl, 1-butenyl, and 1-pentenyl groups; aryl groups such as phenyl, tolyl, and xylyl groups; aralkyl groups such as benzyl and phenethyl groups, and the like.

Among them, R¹ is preferably a hydrogen atom, an unsubstituted linear, branched or cyclic alkyl group having 1 to 10 carbon atoms, an unsubstituted linear, branched or cyclic alkenyl group having 2 to 10 carbon atoms, an unsubstituted aryl group having 6 to 10 carbon atoms, or an unsubstituted aralkyl group having 7 to 10 carbon atoms, and from the viewpoint of easy availability of raw materials, a hydrogen atom, a methyl group, or a phenyl group is more preferable.

In the general formula (1), R² and R³ are each independently an unsubstituted monovalent hydrocarbon group having 1 to 20 carbon atoms or an organoxy group having the following general formula (2), and an organoxy group having the following general formula (2) is preferable.

—OR⁵ (2)

In the formula (2), R⁵ is an unsubstituted monovalent hydrocarbon group having 1 to 20 carbon atoms. Examples of the monovalent hydrocarbon group of R², R³, and R⁵ include the same group as R¹.

In the general formula (1), R⁴ is an unsubstituted divalent hydrocarbon group having 1 to 20 carbon atoms, preferably 1 to 10 carbon atoms, more preferably 1 to 5 carbon atoms, and specific examples thereof include an alkylene group such as a methylene, ethylene, methylethylene, trimethylene, methylpropylene, tetramethylene, hexamethylene, octamethylene, decamethylene, or isobutylene group; arylene groups such as phenylene and methylphenylene groups; and aralkylene groups such as ethylenephenylene and ethylenephenylenemethylene groups.

In a case where R⁴ is a single bond and A is a group having the general formula (3), when the compound (1) is used as the polymer modifier, the N—Si bond is cleaved by hydrolysis or the like, the amino group contained in A is removed from the polymer, and the interaction between the polymer compound and silica is lost. On the other hand, when an unsubstituted divalent hydrocarbon group having 1 to 20 carbon atoms is present as in the present invention, amino group removal by cleavage does not occur even after use as the polymer modifier, and an amino group having a large interaction with silica can be retained in the polymer, so that the interaction between the polymer compound and silica can be increased.

In the general formula (1), A is a group having the following general formula (3) or the following general formula (4).

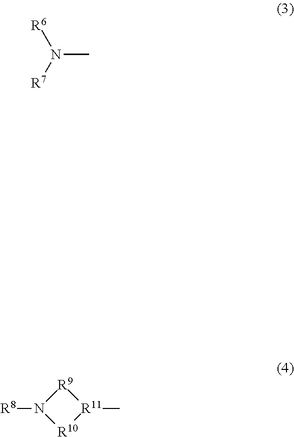

In the general formula (3), R⁶ and R⁷ are a monovalent hydrocarbon group having 1 to 20 carbon atoms, preferably 1 to 10 carbon atoms, more preferably 1 to 6 carbon atoms, in which a hetero atom such as an oxygen atom or a sulfur atom may be interposed, or a triorganosilyl group.

The monovalent hydrocarbon group of R⁶ and R⁷ may be linear, branched, or cyclic, and specific examples thereof include linear alkyl groups such as methyl, ethyl, n-propyl, n-butyl, n-pentyl, n-hexyl, n-heptyl, n-octyl, n-nonyl, n-decyl, n-dodecyl, n-tetradecyl, n-hexadecyl, n-octadecyl, and n-icosyl groups; branched alkyl groups such as isopropyl, isobutyl, sec-butyl, tert-butyl, texyl, 2-ethylhexyl groups; cyclic alkyl groups such as cyclopentyl and cyclohexyl groups; alkenyl groups such as vinyl, allyl, propenyl, 1-butenyl, and 1-pentenyl groups; aryl groups such as phenyl, tolyl, and xylyl groups; aralkyl groups such as benzyl and phenethyl groups, and the like.

Among them, R⁶ and R⁷ are preferably a hydrogen atom, an unsubstituted linear, branched or cyclic alkyl group having 1 to 10 carbon atoms, an unsubstituted linear, branched or cyclic alkenyl group having 2 to 10 carbon atoms, an unsubstituted aryl group having 6 to 10 carbon atoms, or an unsubstituted aralkyl group having 7 to 10 carbon atoms, and from the viewpoint of easy availability of raw materials, a hydrogen atom, a methyl group, or a phenyl group is more preferable.

R⁶ and R⁷ may be bonded to each other to form a ring having 2 to 20 carbon atoms together with the nitrogen atom to which they are bonded.

Examples of such a ring include a piperidine ring, a piperazine ring, a pyrrolidine ring, and a morpholine ring.

Specific examples of the triorganosilyl group include trialkylsilyl groups having an alkyl group having 1 to 6 carbon atoms, such as trimethylsilyl, ethyldimethylsilyl, diethylmethylsilyl, triethylsilyl, tri n-propylsilyl, triisopropylsilyl, tri n-butylsilyl, triisobutylsilyl, tri sec-butylsilyl, tert-butyldimethylsilyl, tricyclopentylsilyl, and tricyclohexylsilyl groups; a triarylsilyl group having an aryl group having 6 to 10 carbon atoms, such as a triphenylsilyl group; and an alkyldiarylsilyl group having an alkyl group having 1 to 6 carbon atoms and an aryl group having 6 to 10 carbon atoms such as a tert-butyldiphenylsilyl group.

In the general formula (4), R⁸ is an unsubstituted monovalent hydrocarbon group having 1 to 20 carbon atoms, preferably 1 to 10 carbon atoms, more preferably 1 to 5 carbon atoms, or a triorganosilyl group, and specific examples thereof include groups similar to R⁶ and R⁷.

R⁹ and R¹⁰ each independently represent an unsubstituted divalent hydrocarbon group having 1 to 20 carbon atoms, preferably 1 to 10 carbon atoms, more preferably 1 to 5 carbon atoms, and specific examples thereof include an alkylene group such as a methylene, ethylene, methylethylene, trimethylene, methylpropylene, tetramethylene, hexamethylene, octamethylene, decamethylene, or isobutylene group; arylene groups such as phenylene and methylphenylene groups; and aralkylene groups such as ethylenephenylene and ethylenephenylenemethylene groups.

R¹¹ represents C—H or a nitrogen atom.

Specific examples of the compound (1) include 4-(dimethylaminomethyldimethylsilyl)styrene, 4-(diethylaminomethyldimethylsilyl)styrene, 4-(dibutylaminomethyldimethylsilyl)styrene, 4-[(N,N-bistrimethylsilyl)aminomethyldimethylsilyl]styrene, 4-(morpholinomethyldimethylsilyl)styrene, 4-[(4-methylpiperazine-1-yl)methyldimethylsilyl]styrene, 4-[(3-dimethylaminopropyl)dimethylsilyl]styrene, 4-[(3-diethylaminopropyl)dimethylsilyl]styrene, 4-[(3-dibutylaminopropyl)dimethylsilyl]styrene, 4-[3-[(N,N-bistrimethylsilyl)aminopropyl]dimethylsilyl]styrene, 4-[(3-morpholinopropyl)dimethylsilyl]styrene, 4-[[3-(4-methylpiperazine-1-yl)propyl]dimethylsilyl]styrene, 4-(dimethylaminomethylmethoxymethylsilyl)styrene, 4-(diethylaminomethylmethoxymethylsilyl)styrene, 4-(dibutylaminomethylmethoxymethylsilyl)styrene, 4-[(N,N-bistrimethylsilyl)aminomethylmethoxymethylsilyl]styrene, 4-(morpholinomethylmethoxymethylsilyl)styrene, 4-[(4-methylpiperazine-1-yl)methylmethoxymethylsilyl]styrene, 4-[(3-dimethylaminopropyl)methoxymethylsilyl]styrene, 4-[(3-diethylaminopropyl)methoxymethylsilyl]styrene, 4-[(3-dibutylaminopropyl)methoxymethylsilyl]styrene, 4-[3-[(N,N-bistrimethylsilyl)aminopropyl]methoxymethylsilyl]styrene, 4-[(3-morpholinopropyl)methoxymethylsilyl]styrene, 4-[[3-(4-methylpiperazine-1-yl)propyl]methoxymethylsilyl]styrene, 4-(dimethylaminomethyldimethoxysilyl)styrene, 4-(diethylaminomethyldimethoxysilyl)styrene, 4-(dibutylaminomethyldimethoxysilyl)styrene, 4-[(N,N-bistrimethylsilyl)aminomethyldimethoxysilyl]styrene, 4-(morpholinomethyldimethoxysilyl)styrene, 4-[(4-methylpiperazine-1-yl)methyldimethoxysilyl]styrene, 4-[(3-dimethylaminopropyl)dimethoxysilyl]styrene, 4-[(3-diethylaminopropyl)dimethoxysilyl]styrene, 4-[(3-dibutylaminopropyl)dimethoxysilyl]styrene, 4-[3-[(N,N-bistrimethylsilyl)aminopropyl]dimethoxysilyl]styrene, 4-[(3-morpholinopropyl)dimethoxysilyl]styrene, 4-[[3-(4-methylpiperazine-1-yl)propyl]dimethoxysilyl]styrene, 4-(dimethylaminomethylethoxymethylsilyl)styrene, 4-(diethylaminomethylethoxymethylsilyl)styrene, 4-(dibutylaminomethylethoxymethylsilyl)styrene, 4-[(N,N-bistrimethylsilyl)aminomethylethoxymethylsilyl]styrene, 4-(morpholinomethylethoxymethylsilyl)styrene, 4-[(4-methylpiperazine-1-yl)methylethoxymethylsilyl]styrene, 4-[(3-dimethylaminopropyl)ethoxymethylsilyl]styrene, 4-[(3-diethylaminopropyl)ethoxymethylsilyl]styrene, 4-[(3-dibutylaminopropyl)ethoxymethylsilyl]styrene, 4-[3-[(N,N-bistrimethylsilyl)aminopropyl]ethoxymethylsilyl]styrene, 4-[(3-morpholinopropyl)ethoxymethylsilyl]styrene, 4-[[3-(4-methylpiperazine-1-yl)propyl]ethoxymethylsilyl]styrene, 4-(dimethylaminomethyldiethoxysilyl)styrene, 4-(diethylaminomethyldiethoxysilyl)styrene, 4-(dibutylaminomethyldiethoxysilyl)styrene, 4-[(N,N-bistrimethylsilyl)aminomethyldiethoxysilyl]styrene, 4-(morpholinomethyldiethoxysilyl)styrene, 4-[(4-methylpiperazine-1-yl)methyldiethoxysilyl]styrene, 4-[(3-dimethylaminopropyl)diethoxysilyl]styrene, 4-[(3-diethylaminopropyl) diethoxysilyl]styrene, 4-[(3-dibutylaminopropyl) diethoxysilyl]styrene, 4-[3-[(N,N-bistrimethylsilyl)aminopropyl]diethoxysilyl]styrene, 4-[(3-morpholinopropyl) diethoxysilyl]styrene, 4-[[3-(4-methylpiperazine-1-yl)propyl]diethoxysilyl]styrene, 3-(dimethylaminomethyldimethylsilyl)styrene, 3-(diethylaminomethyldimethylsilyl)styrene, 3-(dibutylaminomethyldimethylsilyl)styrene, 3-[(N,N-bistrimethylsilyl)aminomethyldimethylsilyl]styrene, 3-(morpholinomethyldimethylsilyl)styrene, 3-[(4-methylpiperazine-1-yl)methyldimethylsilyl]styrene, 3-[(3-dimethylaminopropyl)dimethylsilyl]styrene, 3-[(3-diethylaminopropyl)dimethylsilyl]styrene, 3-[(3-dibutylaminopropyl)dimethylsilyl]styrene, 3-[3-[(N,N-bistrimethylsilyl)aminopropyl]dimethylsilyl]styrene, 3-[(3-morpholinopropyl)dimethylsilyl]styrene, 3-[[3-(4-methylpiperazine-1-yl)propyl]dimethylsilyl]styrene, 3-(dimethylaminomethylmethoxymethylsilyl)styrene, 3-(diethylaminomethylmethoxymethylsilyl)styrene, 3-(dibutylaminomethylmethoxymethylsilyl)styrene, 3-[(N,N-bistrimethylsilyl)aminomethylmethoxymethylsilyl]styrene, 3-(morpholinomethylmethoxymethylsilyl)styrene, 3-[(4-methylpiperazine-1-yl)methylmethoxymethylsilyl]styrene, 3-[(3-dimethylaminopropyl)methoxymethylsilyl]styrene, 3-[(3-diethylaminopropyl)methoxymethylsilyl]styrene, 3-[(3-dibutylaminopropyl)methoxymethylsilyl]styrene, 3-[3-[(N,N-bistrimethylsilyl)aminopropyl]methoxymethylsilyl]styrene, 3-[(3-morpholinopropyl)methoxymethylsilyl]styrene, 3-[[3-(4-methylpiperazine-1-yl)propyl]methoxymethylsilyl]styrene, 3-(dimethylaminomethyldimethoxysilyl)styrene, 3-(diethylaminomethyldimethoxysilyl)styrene, 3-(dibutylaminomethyldimethoxysilyl)styrene, 3-[(N,N-bistrimethylsilyl)aminomethyldimethoxysilyl]styrene, 3-(morpholinomethyldimethoxysilyl)styrene, 3-[(4-methylpiperazine-1-yl)methyldimethoxysilyl]styrene, 3-[(3-dimethylaminopropyl)dimethoxysilyl]styrene, 3-[(3-diethylaminopropyl)dimethoxysilyl]styrene, 3-[(3-dibutylaminopropyl)dimethoxysilyl]styrene, 3-[3-[(N,N-bistrimethylsilyl)aminopropyl]dimethoxysilyl]styrene, 3-[(3-morpholinopropyl)dimethoxysilyl]styrene, 3-[[3-(4-methylpiperazine-1-yl)propyl]dimethoxysilyl]styrene, 3-(dimethylaminomethylethoxymethylsilyl)styrene, 3-(diethylaminomethylethoxymethylsilyl)styrene, 3-(dibutylaminomethylethoxymethylsilyl)styrene, 3-[(N,N-bistrimethylsilyl)aminomethylethoxymethylsilyl]styrene, 3-(morpholinomethylethoxymethylsilyl)styrene, 3-[(4-methylpiperazine-1-yl)methylethoxymethylsilyl]styrene, 3-[(3-dimethylaminopropyl)ethoxymethylsilyl]styrene, 3-[(3-diethylaminopropyl)ethoxymethylsilyl]styrene, 3-[(3-dibutylaminopropyl)ethoxymethylsilyl]styrene, 3-[3-[(N,N-bistrimethylsilyl)aminopropyl]ethoxymethylsilyl]styrene, 3-[(3-morpholinopropyl)ethoxymethylsilyl]styrene, 3-[[3-(4-methylpiperazine-1-yl)propyl]ethoxymethylsilyl]styrene, 3-(dimethylaminomethyldiethoxysilyl)styrene, 3-(diethylaminomethyldiethoxysilyl)styrene, 3-[(N,N-bistrimethylsilyl)aminomethyldiethoxysilyl]styrene, 3-(dibutylaminomethyldiethoxysilyl)styrene, 3-(morpholinomethyldiethoxysilyl)styrene, 3-[(4-methylpiperazine-1-yl)methyldiethoxysilyl]styrene, 3-[(3-dimethylaminopropyl)diethoxysilyl]styrene, 3-[(3-diethylaminopropyl) diethoxysilyl]styrene, 3-[(3-dibutylaminopropyl) diethoxysilyl]styrene, 3-[3-[(N,N-bistrimethylsilyl)aminopropyl]diethoxysilyl]styrene, 3-[(3-morpholinopropyl) diethoxysilyl]styrene, 3-[[3-(4-methylpiperazine-1-yl)propyl]diethoxysilyl]styrene, 2-(dimethylaminomethyldimethylsilyl)styrene, 2-(diethylaminomethyldimethylsilyl)styrene, 2-(dibutylaminomethyldimethylsilyl)styrene, 2-[(N,N-bistrimethylsilyl)aminomethyldimethylsilyl]styrene, 2-(morpholinomethyldimethylsilyl)styrene, 2-[(4-methylpiperazine-1-yl)methyldimethylsilyl]styrene, 2-[(3-dimethylaminopropyl)dimethylsilyl]styrene, 2-[(3-diethylaminopropyl)dimethylsilyl]styrene, 2-[(3-dibutylaminopropyl)dimethylsilyl]styrene, 2-[3-[(N,N-bistrimethylsilyl)aminopropyl]dimethylsilyl]styrene, 2-[(3-morpholinopropyl)dimethylsilyl]styrene, 2-[3-(4-methylpiperazine-1-yl)propyl]dimethylsilyl]styrene, 2-(dimethylaminomethylmethoxymethylsilyl)styrene, 2-(diethylaminomethylmethoxymethylsilyl)styrene, 2-(dibutylaminomethylmethoxymethylsilyl)styrene, 2-[(N,N-bistrimethylsilyl)aminomethylmethoxymethylsilyl]styrene, 2-(morpholinomethylmethoxymethylsilyl)styrene, 2-[(4-methylpiperazine-1-yl)methylmethoxymethylsilyl]styrene, 2-[(3-dimethylaminopropyl)methoxymethylsilyl]styrene, 2-[(3-diethylaminopropyl)methoxymethylsilyl]styrene, 2-[(3-dibutylaminopropyl)methoxymethylsilyl]styrene, 2-[3-[(N,N-bistrimethylsilyl)aminopropyl]methoxymethylsilyl]styrene, 2-[(3-morpholinopropyl)methoxymethylsilyl]styrene, 2-[[3-(4-methylpiperazine-1-yl)propyl]methoxymethylsilyl]styrene, 2-(dimethylaminomethyldimethoxysilyl)styrene, 2-(diethylaminomethyldimethoxysilyl)styrene, 2-(dibutylaminomethyldimethoxysilyl)styrene, 2-[(N,N-bistrimethylsilyl)aminomethyldimethoxysilyl]styrene, 2-(morpholinomethyldimethoxysilyl)styrene, 2-[(4-methylpiperazine-1-yl)methyldimethoxysilyl]styrene, 2-[(3-dimethylaminopropyl)dimethoxysilyl]styrene, 2-[(3-diethylaminopropyl)dimethoxysilyl]styrene, 2-[(3-dibutylaminopropyl)dimethoxysilyl]styrene, 2-[3-[(N,N-bistrimethylsilyl)aminopropyl]dimethoxysilyl]styrene, 2-[(3-morpholinopropyl)dimethoxysilyl]styrene, 2-[[3-(4-methylpiperazine-1-yl)propyl]dimethoxysilyl]styrene, 2-(dimethylaminomethylethoxymethylsilyl)styrene, 2-(diethylaminomethylethoxymethylsilyl)styrene, 2-(dibutylaminomethylethoxymethylsilyl)styrene, 2-[(N,N-bistrimethylsilyl)aminomethylethoxymethylsilyl]styrene, 2-(morpholinomethylethoxymethylsilyl)styrene, 2-[(4-methylpiperazine-1-yl)methylethoxymethylsilyl]styrene, 2-[(3-dimethylaminopropyl)ethoxymethylsilyl]styrene, 2-[(3-diethylaminopropyl)ethoxymethylsilyl]styrene, 2-[(3-dibutylaminopropyl)ethoxymethylsilyl]styrene, 2-[3-[(N,N-bistrimethylsilyl)aminopropyl]ethoxymethylsilyl]styrene, 2-[(3-morpholinopropyl)ethoxymethylsilyl]styrene, 2-[[3-(4-methylpiperazine-1-yl)propyl]ethoxymethylsilyl]styrene, 2-(dimethylaminomethyldiethoxysilyl)styrene, 2-(diethylaminomethyldiethoxysilyl)styrene, 2-(dibutylaminomethyldiethoxysilyl)styrene, 2-[(N,N-bistrimethylsilyl)aminomethyldiethoxysilyl]styrene, 2-(morpholinomethyldiethoxysilyl)styrene, 2-[(4-methylpiperazine-1-yl)methyldiethoxysilyl]styrene, 2-[(3-dimethylaminopropyl)diethoxysilyl]styrene, 2-[(3-diethylaminopropyl) diethoxysilyl]styrene, 2-[(3-dibutylaminopropyl) diethoxysilyl]styrene, 2-[3-[(N,N-bistrimethylsilyl)aminopropyl]diethoxysilyl]styrene, 2-[(3-morpholinopropyl) diethoxysilyl]styrene, 2-[[3-(4-methylpiperazine-1-yl)propyl]diethoxysilyl]styrene, 1-[4-(dimethylaminomethyldimethylsilyl)phenyl]-1-phenylethylene, 1-[4-(diethylaminomethyldimethylsilyl)phenyl]-1-phenylethylene, 1-[4-(dibutylaminomethyldimethylsilyl)phenyl]-1-phenylethylene, 1-[4-[(N,N-bistrimethylsilyl)aminomethyldimethylsilyl]phenyl]-1-phenylethylene, 1-[4-(morpholinomethyldimethylsilyl)phenyl]-1-phenylethylene, 1-[4-[(4-methylpiperazin-1-yl)methyldimethylsilyl]phenyl]-1-phenylethylene, 1-[4-[(3-dimethylaminopropyl)dimethylsilyl]phenyl]-1-phenylethylene, 1-[4-[(3-diethylaminopropyl)dimethylsilyl]phenyl]-1-phenylethylene, 1-[4-[(3-dibutylaminopropyl)dimethylsilyl]phenyl]-1-phenylethylene, 1-[4-[3-[(N,N-bistrimethylsilyl)aminopropyl]dimethylsilyl]phenyl]-1-phenylethylene, 1-[4-[(3-morpholinopropyl)dimethylsilyl]phenyl]-1-phenylethylene, 1-[[4-[3-(4-methylpiperazine-1-yl)propyl]dimethylsilyl]phenyl]-1-phenylethylene, 1-[4-(dimethylaminomethylmethoxymethylsilyl)phenyl]-1-phenylethylene, 1-[4-(diethylaminomethylmethoxymethylsilyl)phenyl]-1-phenylethylene, 1-[4-(dibutylaminomethylmethoxymethylsilyl)phenyl]-1-phenylethylene, 1-[4-[(N,N-bistrimethylsilyl)aminomethylmethoxymethylsilyl]phenyl]-1-phenylethylene, 1-[4-(morpholinomethylmethoxymethylsilyl)phenyl]-1-phenylethylene, 1-[4-[(4-methylpiperazine-1-yl)methylmethoxymethylsilyl]phenyl]-1-phenylethylene, 1-[4-[(3-dimethylaminopropyl)methoxymethylsilyl]phenyl]-1-phenylethylene, 1-[4-[(3-diethylaminopropyl)methoxymethylsilyl]phenyl]-1-phenylethylene, 1-[4-[(3-dibutylaminopropyl)methoxymethylsilyl]phenyl]-1-phenylethylene, 1-[4-[3-[(N,N-bistrimethylsilyl)aminopropyl]methoxymethylsilyl]phenyl]-1-phenylethylene, 1-[4-[(3-morpholinopropyl)methoxymethylsilyl]phenyl]-1-phenylethylene, 1-[4-[[3-(4-methylpiperazin-1-yl)propyl]methoxymethylsilyl]phenyl]-1-phenylethylene, 1-[4-(dimethylaminomethyldimethoxysilyl)phenyl]-1-phenylethylene, 1-[4-(diethylaminomethyldimethoxysilyl)phenyl]-1-phenylethylene, 1-[4-(dibutylaminomethyldimethoxysilyl)phenyl]-1-phenylethylene, 1-[4-[(N,N-bistrimethylsilyl)aminomethyldimethoxysilyl]phenyl]-1-phenylethylene, 1-[4-(morpholinomethyldimethoxysilyl)phenyl]-1-phenylethylene, 1-[4-[(4-methylpiperazine-1-yl)methyldimethoxysilyl]phenyl]-1-phenylethylene, 1-[4-[(3-dimethylaminopropyl)dimethoxysilyl]phenyl]-1-phenylethylene, 1-[4-[(3-diethylaminopropyl)dimethoxysilyl]phenyl]-1-phenylethylene, 1-[4-[(3-dibutylaminopropyl)dimethoxysilyl]phenyl]-1-phenylethylene, 1-[4-[3-[(N,N-bistrimethylsilyl)aminopropyl]dimethoxysilyl]phenyl]-1-phenylethylene, 1-[4-[(3-morpholinopropyl)dimethoxysilyl]phenyl]-1-phenylethylene, 1-[4-[[3-(4-methylpiperazine-1-yl)propyl]dimethoxysilyl]phenyl]-1-phenylethylene, 1-[4-(dimethylaminomethylethoxymethylsilyl)phenyl]-1-phenylethylene, 1-[4-(diethylaminomethylethoxymethylsilyl)phenyl]-1-phenylethylene, 1-[4-(dibutylaminomethylethoxymethylsilyl)phenyl]-1-phenylethylene, 1-[4-[(N,N-bistrimethylsilyl)aminomethylethoxymethylsilyl]phenyl]-1-phenylethylene, 1-[4-(morpholinomethylethoxymethylsilyl)phenyl]-1-phenylethylene, 1-[4-[(4-methylpiperazine-1-yl)methylethoxymethylsilyl]phenyl]-1-phenylethylene, 1-[4-[(3-dimethylaminopropyl)ethoxymethylsilyl]phenyl]-1-phenylethylene, 1-[4-[(3-diethylaminopropyl)ethoxymethylsilyl]phenyl]-1-phenylethylene, 1-[4-[(3-dibutylaminopropyl)ethoxymethylsilyl]phenyl]-1-phenylethylene, 1-[4-[3-[(N,N-bistrimethylsilyl)aminopropyl]ethoxymethylsilyl]phenyl]-1-phenylethylene, 1-[4-[(3-morpholinopropyl)ethoxymethylsilyl]phenyl]-1-phenylethylene, 1-[4-[3-(4-methylpiperazine-1-yl)propyl]ethoxymethylsilyl]phenyl]-1-phenylethylene, 1-[4-(dimethylaminomethyldiethoxysilyl)phenyl]-1-phenylethylene, 1-[4-(diethylaminomethyldiethoxysilyl)phenyl]-1-phenylethylene, 1-[4-(dibutylaminomethyldiethoxysilyl)phenyl]-1-phenylethylene, 1-[4-[(N,N-bistrimethylsilyl)aminomethyldiethoxysilyl]phenyl]-1-phenylethylene, 1-[4-(morpholinomethyldiethoxysilyl)phenyl]-1-phenylethylene, 1-[4-[(4-methylpiperazin-1-yl)methyldiethoxysilyl]phenyl]-1-phenylethylene, 1-[4-[(3-dimethylaminopropyl)diethoxysilyl]phenyl]-1-phenylethylene, 1-[4-[(3-diethylaminopropyl)diethoxysilyl]phenyl]-1-phenylethylene, 1-[4-[(3-dibutylaminopropyl)diethoxysilyl]phenyl]-1-phenylethylene, 1-[4-[3-[(N,N-bistrimethylsilyl)aminopropyl]diethoxysilyl]phenyl]-1-phenylethylene, 1-[4-[(3-morpholinopropyl)diethoxysilyl]phenyl]-1-phenylethylene, and 1-[4-[[3-(4-methylpiperazine-1-yl)propyl]diethoxysilyl]phenyl]-1-phenylethylene.

Next, a method for producing the compound (1) of the present invention is described.

The compound (1) can be produced, for example, by reacting a nitrogen-containing silane compound (Hereinafter, the compound is referred to as “compound (5)”.) having the following general formula (5) with a Grignard reagent having the following general formula (6) (Hereinafter, the compound is referred to as “compound (6)”.).

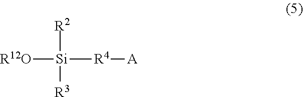

wherein, R² to R⁴ and A represent the same meaning as described above, and R¹² represents an unsubstituted monovalent hydrocarbon group having 1 to 20 carbon atoms.

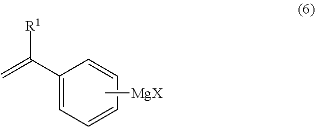

wherein, R¹ has the same meaning as described above, and X represents a chlorine atom, a bromine atom, or an iodine atom.

Specific examples of the compound (5) include dimethylaminomethylmethoxydimethylsilane, diethylaminomethylmethoxydimethylsilane, dibutylaminomethylmethoxydimethylsilane, (N,N-bistrimethylsilyl)aminomethylmethoxydimethylsilane, morpholinomethylmethoxydimethylsilane, (4-methylpiperazine-1-yl)methylmethoxydimethylsilane, (3-dimethylaminopropyl)methoxydimethylsilane, (3-diethylaminopropyl)methoxydimethylsilane, (3-dibutylaminopropyl)methylmethoxydimethylsilane, 3-[(N,N-bistrimethylsilyl)aminopropyl]methoxydimethylsilane, (3-morpholinopropyl)methoxydimethylsilane, 3-[(4-methylpiperazine-1-yl)propyl]methoxydimethylsilane, dimethylaminomethyldimethoxymethylsilane, diethylaminomethyldimethoxymethylsilane, dibutylaminomethyldimethoxymethylsilane, (N,N-bistrimethylsilyl)aminomethyldimethoxymethylsilane, morpholinomethyldimethoxymethylsilane, (4-methylpiperazine-1-yl)methyldimethoxymethylsilane, (3-dimethylaminopropyl)dimethoxymethylsilane, (3-diethylaminopropyl)dimethoxymethylsilane, (3-dibutylaminopropyl)methyldimethoxymethylsilane, 3-[(N,N-bistrimethylsilyl)aminopropyl]dimethoxymethylsilane, (3-morpholinopropyl)dimethoxymethylsilane, 3-[(4-methylpiperazine-1-yl)propyl]dimethoxymethylsilane, dimethylaminomethyltrimethoxysilane, diethylaminomethyltrimethoxysilane, dibutylaminomethyltrimethoxysilane, (N,N-bistrimethylsilyl)aminomethyltrimethoxysilane, morpholinomethyltrimethoxysilane, (4-methylpiperazine-1-yl)methyltrimethoxysilane, (3-dimethylaminopropyl) trimethoxysilane, (3-diethylaminopropyl) trimethoxysilane, (3-dibutylaminopropyl)methyltrimethoxysilane, 3-[(N,N-bistrimethylsilyl)aminopropyl]trimethoxysilane, (3-morpholinopropyl) trimethoxysilane, 3-[(4-methylpiperazine-1-yl)propyl]trimethoxysilane, dimethylaminomethylethoxydimethylsilane, diethylaminomethylethoxydimethylsilane, dibutylaminomethylethoxydimethylsilane, (N,N-bistrimethylsilyl)aminomethylethoxydimethylsilane, morpholinomethylethoxydimethylsilane, (4-methylpiperazine-1-yl)methylethoxydimethylsilane, (3-dimethylaminopropyl)ethoxydimethylsilane, (3-diethylaminopropyl)ethoxydimethylsilane, (3-dibutylaminopropyl)methylethoxydimethylsilane, 3-[(N,N-bistrimethylsilyl)aminopropyl]ethoxydimethylsilane, (3-morpholinopropyl) ethoxydimethylsilane, 3-[(4-methylpiperazine-1-yl)propyl]ethoxydimethylsilane, dimethylaminomethyldiethoxymethylsilane, diethylaminomethyldiethoxymethylsilane, dibutylaminomethyldiethoxymethylsilane, (N,N-bistrimethylsilyl)aminomethyldiethoxymethylsilane, morpholinomethyldiethoxymethylsilane, (4-methylpiperazine-1-yl)methyldiethoxymethylsilane, (3-dimethylaminopropyl) diethoxymethylsilane, (3-diethylaminopropyl) diethoxymethylsilane, (3-dibutylaminopropyl) diethoxymethylsilane, 3-[(N,N-bistrimethylsilyl)aminopropyl]diethoxymethylsilane, (3-morpholinopropyl) diethoxymethylsilane, 3-[(4-methylpiperazine-1-yl)propyl]diethoxymethylsilane, dimethylaminomethyltriethoxysilane, diethylaminomethyltriethoxysilane, dibutylaminomethyltriethoxysilane, (N,N-bistrimethylsilyl)aminomethyltriethoxysilane, morpholinomethyltriethoxysilane, (4-methylpiperazine-1-yl)methyltriethoxysilane, (3-dimethylaminopropyl)triethoxysilane, (3-diethylaminopropyl)triethoxysilane, (3-dibutylaminopropyl)triethoxysilane, 3-[(N,N-bistrimethylsilyl)aminopropyl]triethoxysilane, (3-morpholinopropyl)triethoxysilane, 3-[(4-methylpiperazine-1-yl)propyl]triethoxysilane, and the like.

Specific examples of the compound (6) include 4-styrylmagnesium chloride, 4-styrylmagnesium bromide, 4-styrylmagnesium iodide, 3-styrylmagnesium chloride, 3-styrylmagnesium bromide, 3-styrylmagnesium iodide, 2-styrylmagnesium chloride, 2-styrylmagnesium bromide, 2-styrylmagnesium iodide, 4-(1-phenylvinyl)phenylmagnesium chloride, 4-(1-phenylvinyl)phenylmagnesium bromide, and 4-(1-phenylvinyl)phenylmagnesium iodide.

The compounding ratio of the compound (5) and the compound (6) is not particularly limited, but from the viewpoint of reactivity and productivity, the compounding ratio of the compound (6) is preferably 0.1 to 3.0 mol, more preferably 0.5 to 2 mol, per 1 mol of the compound (5).

The reaction temperature of the above reaction is not particularly limited, but is preferably −40 to 200° C., more preferably 0 to 150° C., and the reaction time is not particularly limited, but is preferably 1 to 40 hours, more preferably 1 to 20 hours. The reaction atmosphere is preferably an inert gas atmosphere such as nitrogen or argon.

The above reaction proceeds even without a solvent, but a solvent can also be used. Examples of the solvent include hydrocarbon solvents such as pentane, hexane, cyclohexane, heptane, isooctane, benzene, toluene, and xylene; ether solvents such as diethyl ether, tetrahydrofuran, and dioxane; ester solvents such as ethyl acetate and butyl acetate; aprotic polar solvents such as acetonitrile, N,N-dimethylformamide, and N-methylpyrrolidone; and chlorinated hydrocarbon solvents such as dichloromethane and chloroform. These solvents may be used singly or in combination of two or more kinds thereof.

From the reaction solution obtained as described above, the target product can be recovered by a usual method such as distillation or distillation of a low-boiling-point compound.

### EXAMPLES

Hereinafter, the present invention is specifically described with reference to Examples, but the present invention is not limited to the following Examples.

### Example 1

A flask equipped with a stirrer, a reflux condenser, a dropping funnel, and a thermometer was charged with 23.5 g (0.1 mol) of (3-diethylaminopropyl) trimethoxysilane and 30 ml of toluene, 43 g of a tetrahydrofuran solution of 4-styrylmagnesium chloride (0.1 mol) was added dropwise at 20 to 30° C. over 1 hour, and the mixture was stirred at that temperature for 1 hour. The reaction solution was filtered, and then the filtrate was distilled to obtain 14.1 g of a fraction having a boiling point of 151 to 153° C./0.3 kPa.

A mass spectrum, a ¹H-NMR spectrum, and an IR spectrum of the obtained fraction were measured. From these results, it was confirmed that the obtained compound was 4-[(3-diethylaminopropyl)dimethoxysilyl]styrene.

### [Mass Spectrum]

m/z 307, 193, 163, 133, 117, 86

### [¹H-NMR Spectrum (Deuterated Chloroform Solvent)]

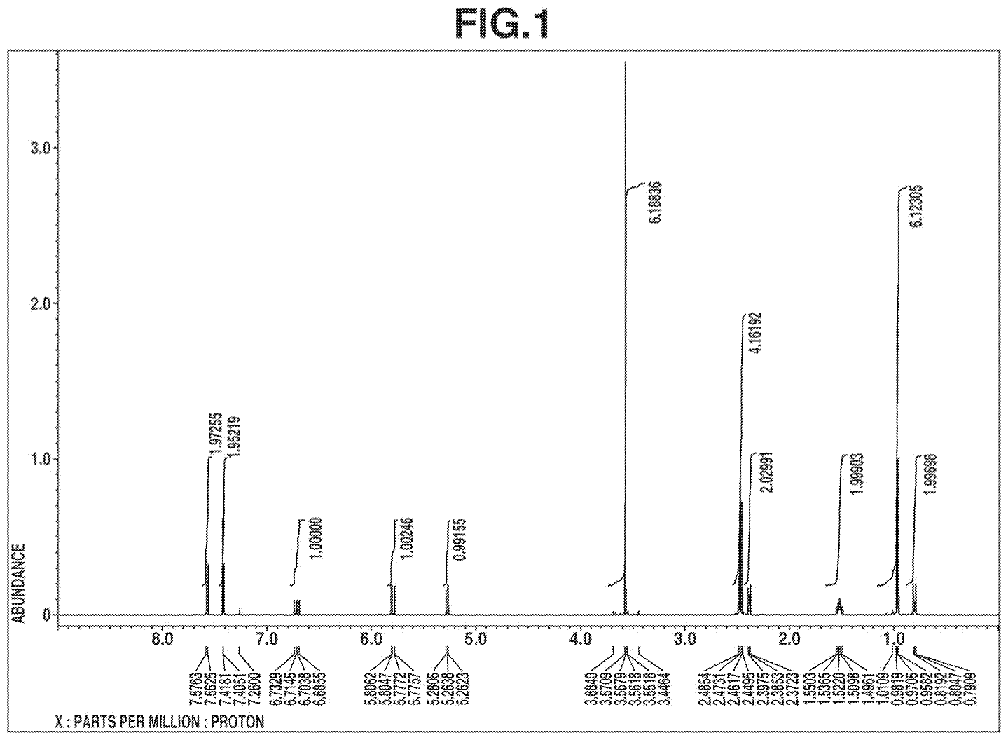

FIG. 1 shows a chart.

### [IR Spectrum]

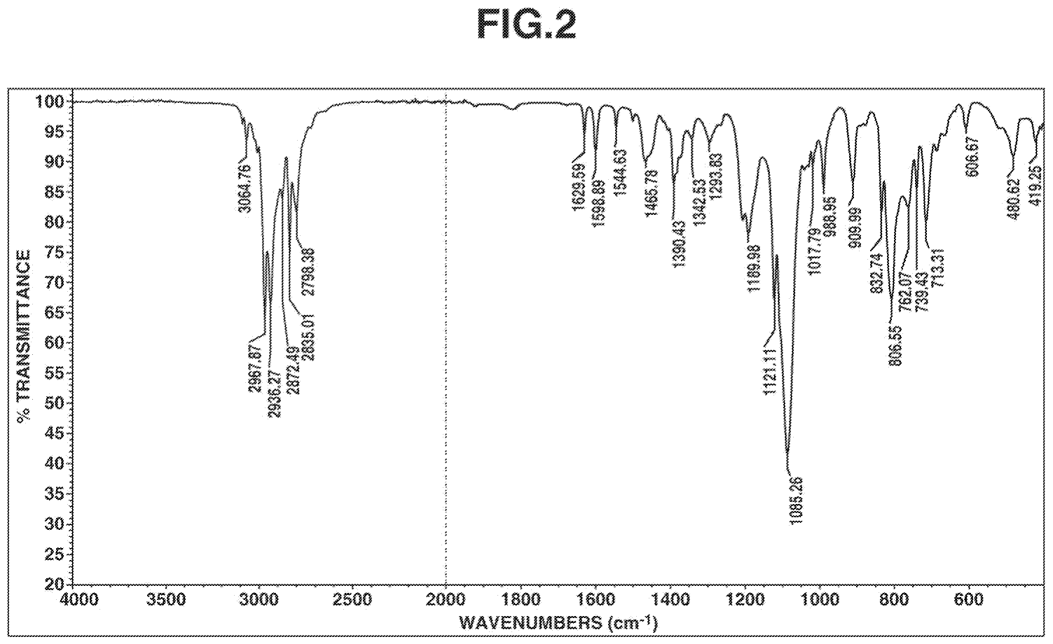

FIG. 2 shows a chart.

### Example 2

A flask equipped with a stirrer, a reflux condenser, a dropping funnel, and a thermometer was charged with 26.2 g (0.1 mol) of 3-[(4-methylpiperazine-1-yl)propyl]-trimethoxysilane and 30 ml of toluene, and 43 g of a tetrahydrofuran solution of 4-styrylmagnesium chloride (0.1 mol) was added dropwise at 20 to 30° C. over 1 hour and stirred at that temperature for 1 hour. The reaction solution was filtered, and then the filtrate was distilled to obtain 5.0 g of a fraction having a boiling point of 168 to 169° C./0.2 kPa.

A mass spectrum, a ¹H-NMR spectrum, and an IR spectrum of the obtained fraction were measured. From these results, it was confirmed that the obtained compound was 4-[[3-(4-methylpiperazine-1-yl)propyl]dimethoxysilyl]styrene.

### [Mass Spectrum]

m/z 334, 193, 163, 133, 113, 70

### [¹H-NMR Spectrum (Deuterated Chloroform Solvent)]

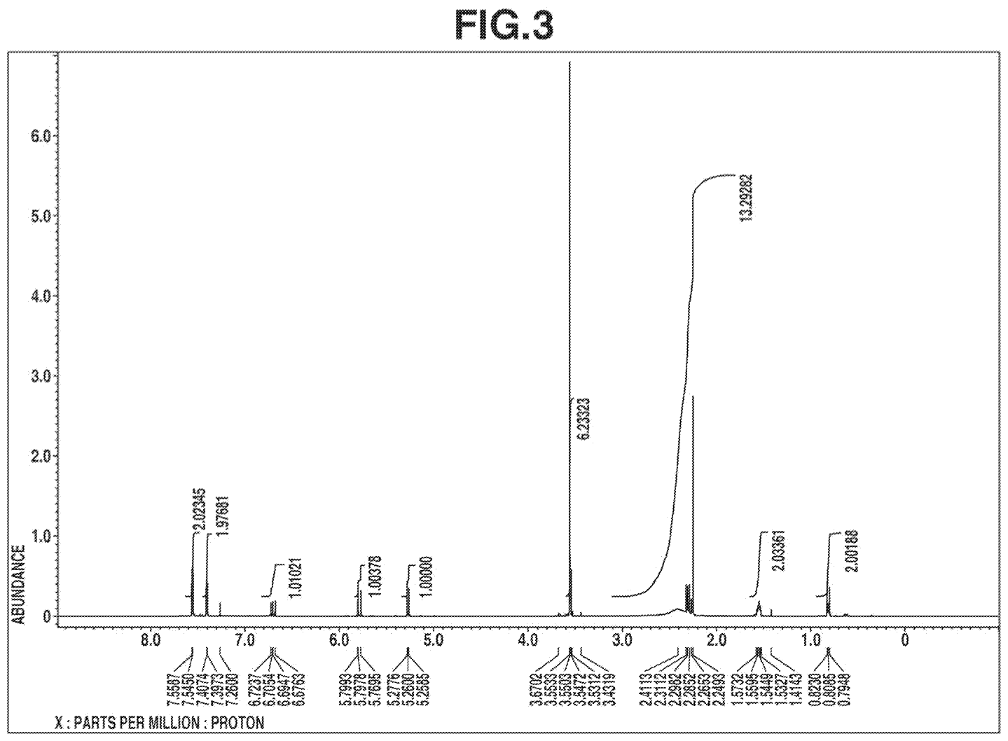

FIG. 3 shows a chart.

### [IR Spectrum]

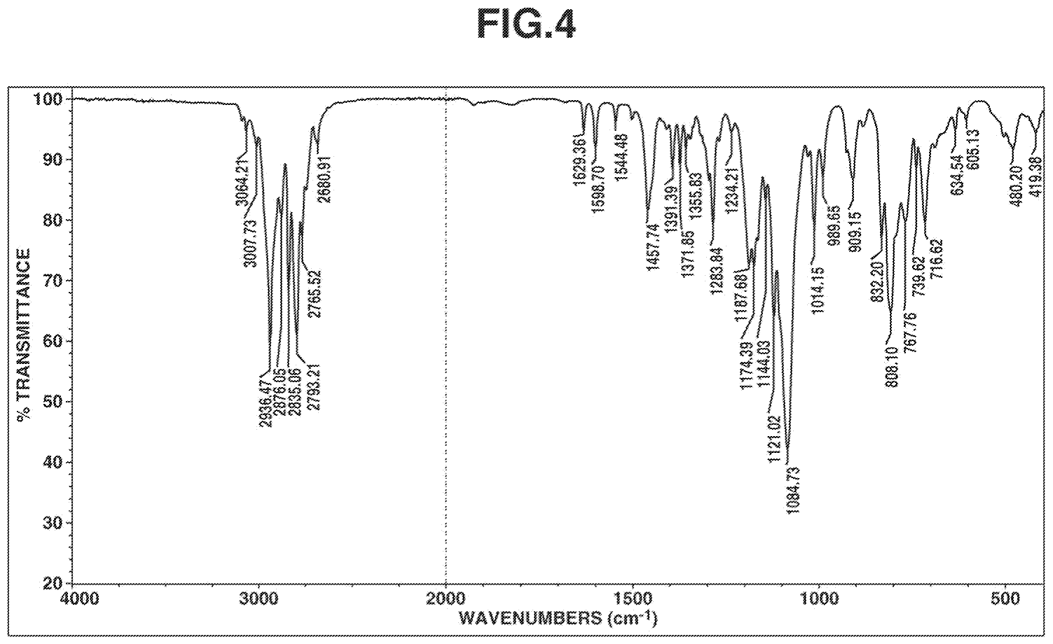

FIG. 4 shows a chart.

### Example 3

A flask equipped with a stirrer, a reflux condenser, a dropping funnel, and a thermometer was charged with 23.5 g (0.1 mol) of (3-diethylaminopropyl) trimethoxysilane and 30 ml of toluene, 50 g of a tetrahydrofuran solution of 4-(1-phenylvinyl)phenylmagnesium chloride (0.1 mol) was added dropwise at 20 to 30° C. over 1 hour, and the mixture was stirred at that temperature for 1 hour. The reaction solution was filtered, and then the filtrate was distilled to obtain 15.3 g of a fraction having a boiling point of 174 to 177° C./0.03 kPa.

A mass spectrum, a ¹H-NMR spectrum, and an IR spectrum of the obtained fraction were measured. From these results, it was confirmed that the obtained compound was 1-[4-[(3-diethylaminopropyl)dimethoxysilyl]phenyl]-1-phenylethylene.

### [Mass Spectrum]

m/z 383, 269, 239, 193, 174, 86

### [¹H-NMR Spectrum (Deuterated Chloroform Solvent)]

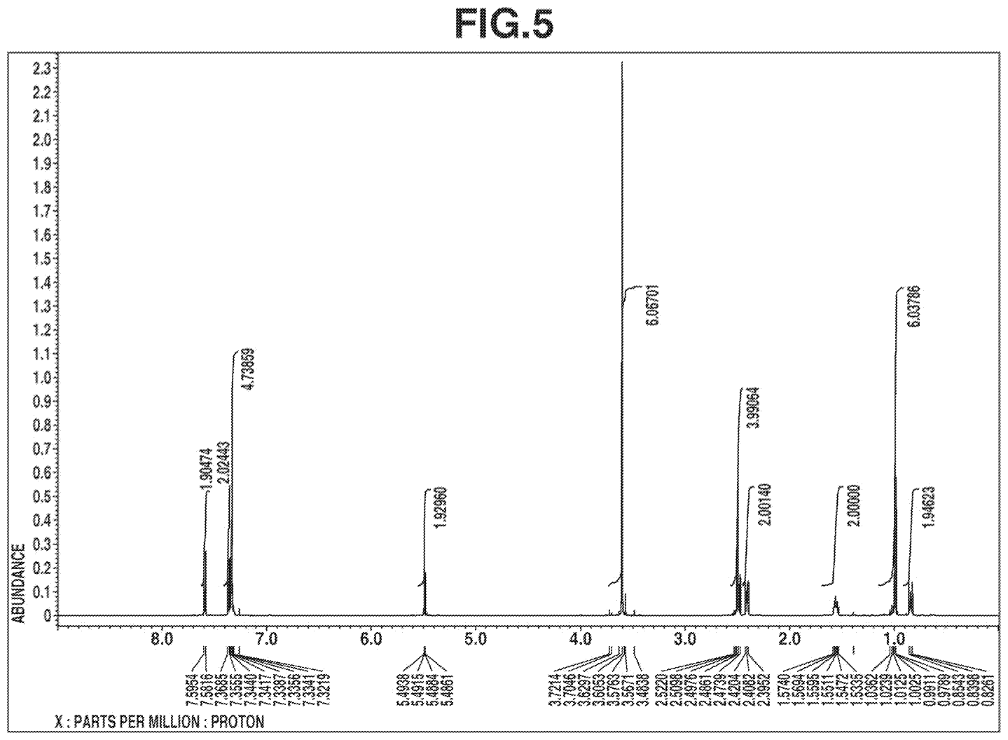

FIG. 5 shows a chart.

### [IR Spectrum]

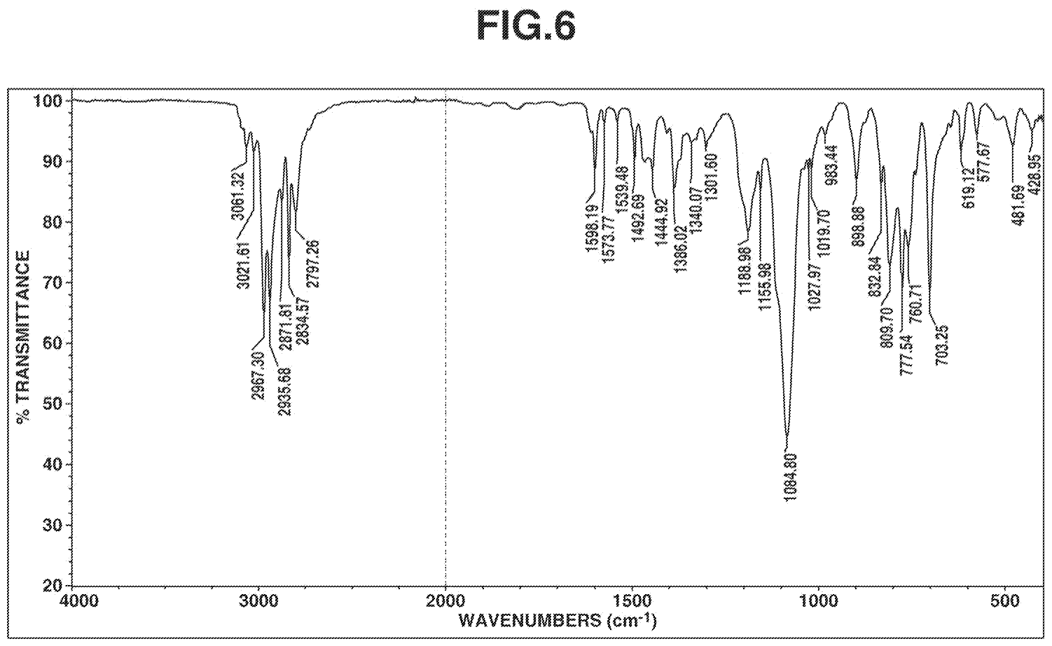

FIG. 6 shows a chart.

Japanese Patent Application No. 2023-179019 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A nitrogen-containing silane compound having the following general formula (1): 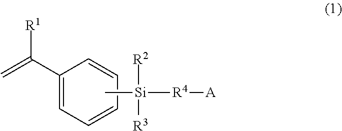
wherein R¹ represents a hydrogen atom or an unsubstituted monovalent hydrocarbon group having 1 to 20 carbon atoms,
R² and R³ each independently represent an unsubstituted monovalent hydrocarbon group having 1 to 20 carbon atoms or a group having the following general formula (2):
—OR⁵ (2)
wherein, R⁵ represents an unsubstituted monovalent hydrocarbon group having 1 to 20 carbon atoms,
R⁴ represents an unsubstituted divalent hydrocarbon group having 1 to 20 carbon atoms,
A represents a group having the following general formula (3) or a group having the following general formula (4): 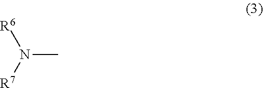
wherein, R⁶ and R⁷ represent a monovalent hydrocarbon group having 1 to 20 carbon atoms in which a hetero atom may be interposed or a triorganosilyl group, and may be bonded to each other to form a ring having 2 to 20 carbon atoms together with a nitrogen atom to which they are bonded: 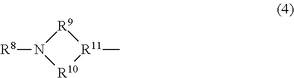
wherein, R⁸ represents an unsubstituted monovalent hydrocarbon group having 1 to 20 carbon atoms or a triorganosilyl group, R⁹ and R¹⁰ each independently represent a divalent hydrocarbon group having 1 to 20 carbon atoms, and R¹¹ represents C—H or a nitrogen atom.

2. A method for producing the nitrogen-containing silane compound according to claim 1, comprising reacting
a nitrogen-containing silane compound having the following general formula (5): 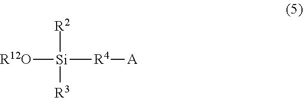
wherein, R² to R⁴ and A represent the same meaning as described above, and R¹² represents an unsubstituted monovalent hydrocarbon group having 1 to 20 carbon atoms with
a Grignard reagent having the following general formula (6): 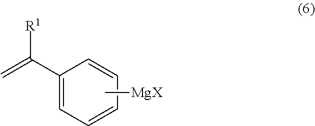
wherein, R¹ has the same meaning as described above, and X represents a chlorine atom, a bromine atom, or an iodine atom.
